(19) United States
(12) Patent Application Publication
(10) Pub. No.: US 2026/0365921 A1
(43) Pub. Date: Nov. 19, 2026

(54) COMPOSITIONS AND METHODS FOR STABILIZING OXIDIZABLE SUBSTRATES USING ANTIOXIDANT

(71) Applicant: ECOLAB USA Inc., St. Paul, MN (US)

(72) Inventors: Ashish DHAWAN, Aurora, IL (US); Julianne TRUFFA, New Lenox, IL (US); Carter Martin SILVERNAIL, Lakeville, MN (US)

(73) Assignee: ECOLAB USA Inc., St. Paul, MN (US)

(21) Appl. No.: 19/663,871

(22) Filed: Apr. 30, 2026

Related U.S. Application Data
(60) Provisional application No. 63/798,927, filed on May 2, 2025.

(51) Int. Cl. C09K 15/24

(52) U.S. Cl. CPC C09K 15/24

(57) ABSTRACT

The present disclosure relates to compositions and methods for stabilizing fluids, such as industrial fluids. The method includes adding a composition to a fluid. The composition includes a eugenol derivative. The methods and compositions may be used in oxidizable industrial fluids, such as a biodiesel, a vegetable oil, a seed oil, a pyrolysis oil, a hydrocarbon, crude oil, a metal-working fluid, a lubricant, or any combination thereof.

### TECHNICAL FIELD

The present disclosure generally relates to compositions and methods for stabilizing oxidizable substrates.

### BACKGROUND

Antioxidants are used in various types of compositions and industries. For example, antioxidants are used to inhibit chemical oxidation of compositions obtained in the petroleum and gas industries. Antioxidants also play important roles as food preservatives and are often added to various food compositions to preserve food properties. A significant number of industrial antioxidants are synthetically produced from fossil oils, including sterically hindered phenols and alkylated diphenylamines. However, due to increasing concerns regarding their environmental and health impacts, there is an emerging demand for bio-based and bio-derived alternatives for industrial uses.

Hydrocarbon-containing compositions can benefit from use of antioxidants. In fats and oils, antioxidants can inhibit oxidation reactions which can otherwise undesirably affect the chemistries of such fats and oils. Natural fats and oils include fatty acid portions that may have regions of unsaturation that are highly susceptible to oxidation. In food products, the oxidation of edible fats and oils can lead to unpleasant odors and tastes, causing spoilage of the food. Oxidation can be caused by exposure to oxygen and sunlight that lead to oxidation of hydrocarbons.

Antioxidants are also added to fuels, such as gasoline and gasoline/ethanol blends, and lubricants to prevent oxidation of hydrocarbons therein. Gasoline fuels can oxidize easily upon exposure to conditions, such as heat, oxygen, and ultraviolet light. Oxidation products result in gum or sediment within the fuel and thereby leading to problems such as plugging and corrosion of internal combustion engines. Antioxidants can prevent the polymerization of compounds in gasoline otherwise leading to residues that can damage internal combustion engines.

As an alternative to fuels and lubricants obtained from fossil sources, there has been more interest the use of renewable raw materials to produce biofuels and lubricants. In particular, biodiesel fuel and biolubricants have gained in popularity due to their performance properties, which can be similar and, in some cases, superior to petroleum-based fuels and lubricants. Biodiesel and biolubricants are typically derived from raw materials that are vegetable oils (i.e., glycerides), for example, soy, palm, rapeseed, sunflower, and coconut oils. These oils are typically converted to fatty acid alkyl esters by a transesterification reaction. Most commonly, the transesterification process reacts the oils with methanol under basic catalysis to generate fatty acid methyl esters (FAMEs). While the use of biodiesel and biolubricants offers great commercial potential, there are various technical challenges associate with their preparation and use.

One challenge for the preparation and use of biodiesel and biolubricants is preserving the oxidation stability of these compositions. While vegetable oil raw materials have some protection from oxidation by naturally occurring antioxidants like tocopherols, the manufacturing and refining processes for biodiesel and biolubricants can remove these natural antioxidants.

Without antioxidants, a reduction in the oxidation stability of the biodiesel and biolubricants makes them susceptible to oxidative degradation. Oxidative biodiesel composition may deteriorate the properties of the biodiesel and cause problems with its use. Fatty acid esters in degradation can be caused and accelerated by factors such as contaminants (e.g., trace metals), contact with metal surfaces, aeration, and physical factors, such as heat and ultraviolet light. For example, oxidation of biodiesel components by interaction with air and metal surfaces results in the formation of hydroperoxide radicals. These radicals promote free-radical chain reactions that cause the formation of oxidized chemical compounds of low molecular weight, like acids, aldehydes, and ketones. Polymeric gums are also formed as a result of oxidation. Polymeric gums lead to many problems such as inadequate fuel combustion, deposits on engine parts such as injectors and pistons, and plugging of injectors and fuel lines. Therefore, oxidation not only reduces the effectiveness of the biodiesel, but it also causes long term mechanical problems in the engine and associated parts.

Antioxidants are used in biodiesel and biolubricants typically to prevent the oxidation of components therein, such as FAMEs. However, the use of known antioxidants can be challenging. Some conventional antioxidants are required need to be used at elevated concentrations to be useful as antioxidants, but often these antioxidants are not very effective in controlling peroxides formation as a result of interaction of the biodiesel with air. First, the antioxidant should be compatible with bio-based fuels and lubricants that are derived from a wide variety of plant-based materials, and should not demonstrate any adverse interactions with components in the bio-based compositions. Also, the antioxidant should be compatible with biodiesel blends, such as biodiesel that includes blends of (plant-based) biodiesel with petroleum-derived diesel. Also, added antioxidants should not adversely impact the properties of these materials, such as ignition and combustion properties, and flow properties of biodiesel, especially flow properties of biodiesel at low temperatures.

Added antioxidants should also cause minimal environmental impact, especially when used with biodiesel. Some conventional antioxidants include sulfur chemistries, the use of which can be undesirable from an environmental standpoint.

### BRIEF SUMMARY

In some aspects, the present disclosure provides methods of stabilizing an oxidizable substrate, such as an oxidizable fluid. Stabilizing may include preventing or inhibiting oxidation of a substrate. In some embodiments, the methods described herein may comprise adding an effective amount of a composition to the oxidizable substrate (e.g., oxidizable fluid), the composition comprising a eugenol derivative.

In some aspects, the present disclosure provides a eugenol derivative of formula I:

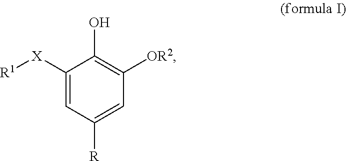

or a salt thereof, wherein: each of X, R, R¹, and R² is as described herein.

The present disclosure also provides an antioxidant, such as a bio-derived antioxidant, for industrial uses. In one aspect, eugenol, isoeugenol, or coniferyl alcohol is a precursor for providing an antioxidant, such as a eugenol derivative as described herein.

The present disclosure also provides an effective antioxidant for a broad spectrum of oxidizable substrates, such as oxidizable fluids like a biodiesel, a vegetable oil, a seed oil, a pyrolysis oil, a hydrocarbon, crude oil, a metal-working fluid, a lubricant, or any combination thereof. Other oxidizable substrates include, but are not limited to, plastics, polymers, elastomer, tires and cables.

In another aspect, the present disclosure provides a composition including an oxidizable fluid and an antioxidant, such as a eugenol derivative. The oxidizable fluid, for example, may be a biodiesel, a vegetable oil, a seed oil, a pyrolysis oil, a hydrocarbon, crude oil, a metal-working fluid, a lubricant, or any combination thereof.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 shows the oxidation induction time (min) of eugenol, 2,6-di-tert-butylphenol, and eugenol diol in untreated biodiesel using (Pressure Differential Scanning Calorimetry) PDSC;

FIG. 2 shows the oxidation induction time % improvement for eugenol, 2,6-di-tert-butylphenol (2,6-DTBP), and eugenol diol relative to untreated biodiesel blank (no AO) using PDSC;

FIG. 3 shows the oxidation stability index (hours) of eugenol, 2,6-di-tert-butylphenol, and eugenol diol in untreated biodiesel using Rancimat;

FIG. 4 shows the oxidation induction time of eugenol, 2,6-di-tert-butylphenol, and eugenol diol in untreated pyrolysis oil-1 using PDSC;

FIG. 5 shows the oxidation induction time % improvement for eugenol, 2,6-di-tert-butylphenol, and eugenol diol relative to untreated pyrolysis oil-1 (no AO) using PDSC; and

FIG. 6 shows the oxidation induction time of eugenol, 2,6-di-tert-butylphenol, and eugenol diol in untreated waxy pyrolysis oil using PDSC.

### DETAILED DESCRIPTION

Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

Additional advantages and novel features of the present disclosure will be set forth in part in the description that follows, and in part will become apparent to those skilled in the art upon examination of the following, or may be learned through routine experimentation upon practice of the present disclosure.

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present application. All publications, patent applications, patents and other references mentioned herein are incorporated by reference in their entirety.

The present disclosure provides compositions and methods for stabilizing an oxidizable substrate, such as an oxidizable fluid. The stability of the oxidizable substrate can be improved by additives that inhibit, prevent or reduce gum formation, discoloration and oxidation. In some embodiments, stability is achieved by use of stabilizers, such as antioxidants. Compositions comprising antioxidants are disclosed herein and may be used in methods for stabilizing oxidizable substrates, such as oxidizable fluids, by preventing or inhibiting oxidation of the substrate.

In some embodiments, the present disclosure provides an antioxidant, such as a bio-derived antioxidant. In some embodiments, eugenol, a phenolic natural compound extracted from plants and certain types of lignin, is a precursor for providing an antioxidant. Eugenol, for example, is known for its antimicrobial, antifungal, antioxidant, anticancer, anti-inflammatory, analgesic, repellent, and insecticidal activities for biological applications, thus, it is widely used in food processing, biomedical industries, and a variety of pharmaceutical, cosmetic, and dental care applications. Eugenol, and similar compounds, such as isoeugenol and coniferyl alcohol, are each naturally occurring renewable phenol compounds. The sustainable origin of eugenol, isoeugenol, and coniferyl alcohol offers ecological benefits in their use as precursors of a eugenol derivative as described herein. In some embodiments, eugenol, isoeugenol, or coniferyl alcohol is a precursor of a eugenol derivative as described herein.

The term “antioxidant” as used herein is a compound that can inhibit, prevent or reduce oxidation, deterioration, degradation and gum formation. Antioxidants are capable of acting as scavengers preventing free radical formation. In one example, an antioxidant is a stabilizer.

The term “oxidative stability” as used herein refers to the susceptibility of a fluid to oxidative degradation. Oxidative stability may be measured by oxidation stability index (OSI), oxidation induction time (OIT), or oxidation temperature (OT).

The term “oxidizable substrate” refers to a composition comprising one or more components that are susceptible to oxidative degradation. Examples of oxidizable substrates include fluids, plastics, polymers, elastomer, tires, cables, and the like.

The term “eugenol” as used herein refers to a compound of the structure:

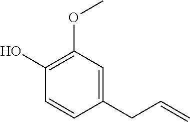

(4-allyl-2-methoxyphenol), or a salt thereof.

The term “isoeugenol” as used herein refers to a compound of the structure:

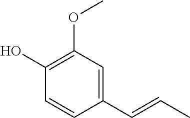

(2-methoxy-4-[prop-1-enyl]phenol), or a salt thereof.

The term “coniferyl alcohol” as used herein refers to a compound of the structure:

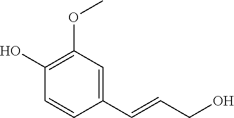

(4-[3-hydroxyprop-1-en-1-yl]-2-methoxyphenol), or a salt thereof.

The term “eugenol derivative” refers to a chemically modified eugenol, isoeugenol, or coniferyl alcohol, or salt thereof. In some embodiments, a eugenol derivative is a compound of eugenol, isoeugenol, or coniferyl alcohol in which 1, 2, or 3 hydrogen atoms of the phenyl ring are substituted. For example, a eugenol derivative may have the structure:

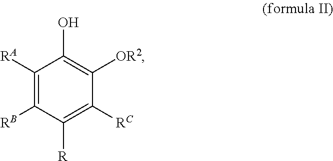

wherein 1, 2, or 3 of R^{A}, R^{B}, and R^{C} is not hydrogen, and R and R² are as described herein. In some embodiments, 1, 2, or 3 of R^{A}, R^{B}, and R^{C} is halo, hydroxy, amino, alkoxy, alkyl, or aryl.

It will be understood that eugenol, isoeugenol, coniferyl alcohol, and eugenol derivative preferably refers to a structure with a free phenolic hydroxy group (—OH) or salt thereof, however, in some instances, may also refer to a structure with a protected phenolic hydroxy group (—OH) or salt thereof.

The term “stabilizer” as used herein refers to a composition that inhibits, prevents, or reduces oxidation, discoloration, deterioration, or degradation of the oxidizable fluid feedstock, formation or settling out of insoluble products (e.g., gums), or combinations thereof.

The presently disclosed term “stabilizer” may be used to cover both “stabilizer” compounds as well as “antioxidant” compounds. In some embodiments, however, the term may be used to cover only “stabilizer” compounds or “antioxidant” compounds, and such embodiments will be explicitly indicated as such.

The terms “C_{x-y}” or “Cₓ-C_{y}”, when used in conjunction with a chemical moiety, such as, alkyl, alkenyl, alkynyl, acyl, acyloxy, or alkoxy are meant to include groups that contain from x to y carbons in the chain. C₀ alkyl indicates a hydrogen where the group is in a terminal position or a bond if internal. A C₁₋₆ alkyl group, for example, contains from one to six carbon atoms in the chain.

The term “alkyl” refers to a straight- or branched-chain monovalent hydrocarbon group. The term “alkylene” refers to a straight- or branched-chain divalent hydrocarbon group. In some embodiments, it can be advantageous to limit the number of atoms in an “alkyl” or “alkylene” to a specific range of atoms, such as C₁-C₃₆ alkyl or C₁-C₃₆ alkylene, C₁-C₁₈ alkyl or C₁-C₁₈ alkylene, or C₁-C₆ alkyl or C₁-C₆ alkylene. Unless otherwise indicated, an alkyl or alkylene group as described herein alone or as part of another group is an optionally substituted linear or branched saturated hydrocarbon chain containing from, for example, one to about thirty-six carbon atoms or one to about eighteen carbon atoms, in the main chain. Examples of alkyl groups include methyl, ethyl, n-propyl, i-propyl, n-butyl, i-butyl, s-butyl, t-butyl, n-pentyl, i-pentyl, s-pentyl, t-pentyl, and the like. Examples of alkylene groups include methylene (—CH₂—), ethylene ((—CH₂—)₂), n-propylene ((—CH₂—)₃), iso-propylene ((—C(H)(CH₃)CH₂—)), n-butylene ((—CH₂—)₄), and the like. An alkyl or alkylene group can be substituted with any of the substituents in the various embodiments described herein, including one or more of such substituents, such as amino and/or hydroxy groups.

The term “alkenyl” refers to a straight- or branched-chain monovalent hydrocarbon group having one or more double bonds. In some embodiments, it can be advantageous to limit the number of atoms in an “alkenyl” to a specific range of atoms, such as C₂-C₆₀ alkenyl, C₂-C₃₆ alkenyl, C₂-C₁₈ alkenyl, or C₂-C₆ alkenyl. Unless otherwise indicated, an alkenyl group as described herein alone or as part of another group is an optionally substituted linear or branched hydrocarbon chain containing from, for example, one to about sixty carbon atoms, such as one to about thirty-six carbon atoms or one to about eighteen carbon atoms, in the main chain. Examples of alkenyl groups include ethenyl (or vinyl), allyl, and but-3-en-1-yl. Included within this term are cis and trans isomers and mixtures thereof. A double bond of an alkenyl group may be represented by the structure “=” or “ [symbol] .” It will be appreciated that a double bond represented by the structure “ [symbol] ” may represent an unspecified cis or trans configuration or a mixture of cis and trans configurations. It will be appreciated that an alkenyl can be unsubstituted or substituted as described herein. An alkenyl group can be substituted with any of the substituents in the various embodiments described herein, including one or more of such substituents, such as hydroxy groups.

An alkyl, alkylene, alkenyl, and alkenylene group can be substituted with any of the substituents in the various embodiments described herein, including one or more of such substituents. It will be understood that alkyl, alkylene, alkenyl, and alkenylene may be combined with other groups, such as those provided above, to form a functionalized alkyl, alkylene, alkenyl, or alkenylene. A functionalized alkyl, alkylene, alkenyl, and alkenylene group can be substituted with any of the substituents in the various embodiments described herein, including one or more of such substituents, such as halogen, hydroxy, amino, alkoxy, alkyl, or aryl groups. By way of example, the combination of an “alkyl” group, as described herein, with a “amino” group may be referred to as an “alkylene-amino” group or “aminoalkyl” as illustratively represented by the structure:

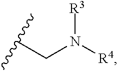

wherein R³ and R⁴, each independently represent a hydrogen or a hydrocarbyl group, or R³ and R⁴ taken together with the N atom to which they are attached complete a heterocycle having from 4 to 8 atoms in the ring structure.

The term “alkylamino” refers to an amino group substituted with at least one alkyl group. Examples of such alkylamino group include —NHC₁-C₆ alkyl, —N(C₁-C₆ alkyl)₂, or —NR³R⁴ wherein R³ and R⁴ come together on the nitrogen atom to which they are attached to form a 3- to 12-membered heterocycle. An alkylamino group can be substituted with any of the substituents in the various embodiments described herein, including one or more of such substituents. For example, an alkylamino group may be unsubstituted or further substituted with one or more hydroxy group.

The term “cycloalkyl” refers to a monovalent cyclic alkyl group containing from, for example, about 3 to about 12 carbon atoms, preferably from about 4 to about 8 carbon atoms, and more preferably from about 4 to about 6 carbon atoms. The term “cycloalkylene” refers to a divalent cyclic alkyl group containing from, for example, about 3 to about 12 carbon atoms, preferably from about 4 to about 8 carbon atoms, and more preferably from about 4 to about 6 carbon atoms. Examples of such cycloalkyl and cycloalkylene groups include cyclopropyl, cyclobutyl, cyclopentyl, cyclohexyl, cycloheptyl, cyclooctyl, and the like. Examples of such cycloalkylene groups include cyclopropylene, cyclobutylene, cyclopentylene, cyclohexylene, cycloheptylene, cyclooctylene, and the like. A cycloalkyl or cycloalkylene group can be substituted with any of the substituents in the various embodiments described herein, including one or more of such substituents. For example, the cycloalkyl or cycloalkylene groups may be unsubstituted or further substituted with hydroxy groups or alkyl groups, such as methyl groups, ethyl groups, and the like.

The term “aryl” includes monovalent substituted or unsubstituted aromatic groups in which each atom of the ring is carbon. The term “arylene” includes bivalent substituted or unsubstituted aromatic groups in which each atom of the ring is carbon. Preferably the ring is a 5- to 10-membered ring, more preferably a 6-membered (e.g., phenyl) or a 10-membered (e.g., naphthyl) ring. The terms “aryl” and “arylene” also include polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. The terms “aryl” and “arylene” apply to cyclic groups that are planar and comprise 4n+2 electrons, according to Huckel's Rule. The term “aryl” includes both unsubstituted and substituted aryl groups, the latter of which refers to aryl moieties having substituents replacing a hydrogen. Examples of such aryl groups include phenyl, naphthyl, benzofuran, indole, benzodioxole, chromone, and the like. Representative examples of substituted aryl groups include, but are not limited to, hydroxyphenyl, carboxyphenyl, methoxyphenyl, and 4-hydroxy-3-methoxyphenyl.

The term “alkoxy” refers to an alkyl group having an oxygen attached thereto. Representative alkoxy groups include methoxy, ethoxy, propoxy, tert-butoxy and the like.

The terms “amine” and “amino” are art-recognized and refer to both unsubstituted and substituted amines and salts thereof, e.g., a moiety that can be represented by

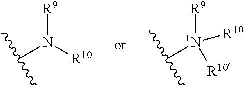

wherein R⁹, R¹⁰, and R^{10′}, each independently represent a hydrogen or a hydrocarbyl group, or R⁹ and R¹⁰ taken together with the N atom to which they are attached complete a heterocycle having from 3 to 12 atoms, preferably from 4 to 8 atoms, in the ring structure.

The term “aminoalkyl”, as used herein, refers to an alkyl group substituted with an amino group. An aminoalkyl group can be substituted with any of the substituents in the various embodiments described herein, including one or more of such substituents, such as amino and/or hydroxy groups.

The term “halo” or “halogen” refers to fluorine, chlorine, bromine, or iodine.

As used herein, the terms “heterocycloalkyl,” “heterocyclyl,” or “heterocycle” refers to a monocyclic or fused ring group having in the ring(s) from 3 to 12 ring atoms, preferably from about 4 to about 8 ring atoms, in which at least one ring atom is a heteroatom, such as nitrogen, oxygen or sulfur, the remaining ring atoms being carbon atoms. Heterocycloalkyl may optionally contain 1, 2, 3 or 4 heteroatoms. A heterocycloalkyl group may be fused to another group such as another heterocycloalkyl, or aryl group. Heterocycloalkyl may also have one of more double bonds, including double bonds to nitrogen (e.g., C═N or N═N) but does not contain a completely conjugated pi-electron system. It will be understood that in certain embodiments, heterocycloalkyl may be advantageously of limited size such as 3- to 7-membered heterocycloalkyl, 5- to 7-membered heterocycloalkyl, 3-, 4-, 5- or 6-membered heterocycloalkyl, and the like. Heterocycloalkyl may be unsubstituted, or substituted as described for alkyl or as described in the various embodiments provided herein. Illustrative heterocycloalkyl groups include, but are not limited to, oxiranyl, thianaryl, azetidinyl, oxetanyl, tetrahydrofuranyl, pyrrolidinyl, tetrahydropyranyl, piperidinyl, dioxanyl, morpholinyl, dithianyl, piperazinyl, oxepanyl, and the like.

The terms “hydroxy” and “hydroxyl” refer to a group represented by —OH.

The term “hydrocarbyl”, as used herein, refers to a group that is bonded through a carbon atom that does not have a ═O or ═S substituent, and typically has at least one carbon-hydrogen bond and a primarily carbon backbone, but may optionally include heteroatoms. Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, heteroaryl, carbocycle, heterocycle, alkyl, alkenyl, alkynyl, and combinations thereof.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, carboxy groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include hydroxy, a C₁-C₆ alkyl group optionally substituted with a hydroxy, a C₃-C₂₀ cycloalkyl group optionally substituted with a hydroxy, or a C₆-C₁₀ aryl group optionally substituted with a hydroxy. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the terms “salt” or “or salt thereof” are used to refer to an acid addition salt or a base addition salt of compounds of present disclosure. The selection of the appropriate salt will be known to a person skilled in the art.

It has been discovered that fluids, such as industrial fluids, can be stabilized using a composition comprising, consisting essentially of, or consisting of a eugenol derivative. For example, the oxidizable fluids can be stabilized using an effective amount of a eugenol derivative.

In some embodiments, the present disclosure provides methods of stabilizing an oxidizable substrate, such as an oxidizable fluid. In some embodiments, the methods comprise adding a composition comprising a eugenol derivative to the oxidizable fluid. In some embodiments, the method comprises producing a eugenol derivative and adding a composition comprising the eugenol derivative to the oxidizable fluid. In some embodiments, the step of producing the eugenol derivative comprises reacting an aldehyde and an amine, thereby providing an intermediate, and reacting the intermediate with eugenol, isoeugenol, or coniferyl alcohol, thereby providing the eugenol derivative.

In some embodiments, the eugenol derivative is of formula I:

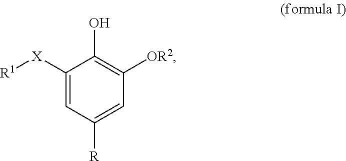

or a salt thereof, wherein: X is alkylene (e.g., C₁-C₆ alkylene); R is alkenyl (e.g., C₂-C₆ alkenyl); R¹ is amino (e.g., —NR³R⁴; wherein R³ and R⁴ are each independently H, alkyl, or aryl; provided that at least one of R³ or R⁴ is not H); and R² is alkyl (e.g., C₁-C₆ alkyl).

In some embodiments, the eugenol derivative is of formula Ia:

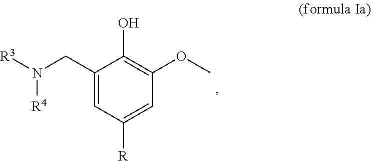

or a salt thereof, wherein R is alkenyl; and R³ and R⁴ are each independently H, alkyl, or aryl; or R³ and R⁴ come together on the nitrogen atom to which they are attached to form a 3- to 12-membered heterocycle; provided that at least one of R³ or R⁴ is not H.

In some embodiments of formula I, X is alkylene (e.g., C₁-C₆ alkylene). In some embodiments, X is C₁-C₆ alkylene, wherein each hydrogen atom of C₁-C₆ alkylene is independently optionally substituted by halogen, hydroxy, amino, C₁-C₆ alkoxy, C₁-C₆ alkyl, or C₆-C₁₀ aryl. In some embodiments, X is C₁-C₆ alkylene, wherein each hydrogen atom of C₁-C₆ alkylene is independently optionally substituted by C₁-C₆ alkyl (e.g., substituted or unsubstituted methyl) or C₆-C₁₀ aryl (e.g., substituted or unsubstituted phenyl). In some embodiments, X is methylene, wherein each hydrogen atom of C₁-C₆ alkylene is independently optionally substituted by C₁-C₆ alkyl (e.g., substituted or unsubstituted methyl) or C₆-C₁₀ aryl (e.g., substituted or unsubstituted phenyl). In some embodiments, X is unsubstituted methylene.

In some embodiments of formula I, R¹ is amino (e.g., —NR³R⁴). In some embodiments, R¹ is alkylamino (e.g., —NHC₁-C₆ alkyl or —N(C₁-C₆ alkyl)₂). In some embodiments, R¹ comprises at least one (e.g., 1, 2, 3, or 4) hydroxy group. In some embodiments, R¹ comprises two hydroxy groups (e.g., a diol). In some embodiments, R¹ is

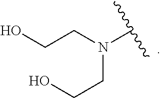 [SMILES: *N(CCO)CCO]

In some embodiments of formula I, —X—R¹ comprises at least one (e.g., 1, 2, 3, or 4) hydroxy group. In some embodiments, —X—R¹ comprises two hydroxy groups (e.g., a diol).

In some embodiments of formula I or Ia, R is alkenyl (e.g., C₂-C₆ alkenyl. In some embodiments, R is C₂-C₆ alkenyl (e.g., C₂-C₃ alkenyl such as vinyl or allyl), wherein each hydrogen atom of C₂-C₆ alkenyl is independently optionally substituted by halogen, hydroxy, amino, C₁-C₆ alkoxy, C₁-C₆ alkyl, or C₆-C₁₀ aryl. In some embodiments, R is propenyl, wherein each hydrogen atom of propenyl is independently optionally substituted by halogen, hydroxy, amino, C₁-C₆ alkoxy, C₁-C₆ alkyl, or C₆-C₁₀ aryl. In some embodiments, R is propenyl or hydroxypropenyl. In some embodiments, R is selected from the group consisting of

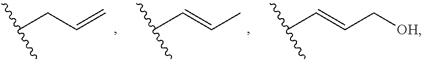

and combinations thereof.

In some embodiments of formula I, R² is alkyl (e.g., C₁-C₆ alkyl). In some embodiments, R² is C₁-C₆ alkyl, wherein each hydrogen atom of C₁-C₆ alkyl is independently optionally substituted by halogen, hydroxy, amino, C₁-C₆ alkoxy, C₁-C₆ alkyl, or C₆-C₁₀ aryl. In some embodiments, R² is unsubstituted C₁-C₃ alkyl (e.g., methyl, ethyl, or propyl). In some embodiments, R² is unsubstituted methyl.

In some embodiments of formula I or Ia, R³ and R⁴ are each independently H, alkyl (e.g., C₁-C₆ alkyl), or aryl (e.g., C₆-C₁₀ aryl). In some embodiments, R³ and R⁴ are each independently H, C₁-C₆ alkyl, or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl; or R³ and R⁴ come together on the nitrogen atom to which they are attached to form a 3- to 12-membered heterocycle, wherein each hydrogen atom of 3- to 12-membered heterocycle is independently optionally substituted by halogen, hydroxy, amino, C₁-C₆ alkoxy, or C₁-C₆ alkyl, or C₆-C₁₀ aryl.

In some embodiments of formula I or Ia, R³ and R⁴ are each independently H, alkyl (e.g., C₁-C₆ alkyl), or aryl (e.g., C₆-C₁₀ aryl). In some embodiments, R³ and R⁴ are each independently H, C₁-C₆ alkyl, or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl. In some embodiments, R³ and R⁴ are each independently C₁-C₆ alkyl or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl. In some embodiments, R³ and R⁴ are each independently C₁-C₆ alkyl (e.g. C₁-C₃ alkyl, such as methyl, ethyl, or propyl), wherein each hydrogen atom of C₁-C₆ alkyl is independently optionally substituted by halogen, hydroxy, amino, C₁-C₆ alkoxy, C₁-C₆ alkyl, or C₆-C₁₀ aryl. In some embodiments, R³ and R⁴ are each independently C₁-C₆ alkyl (e.g. C₁-C₃ alkyl, such as methyl, ethyl, or propyl), wherein at least one (e.g., 1, 2, or 3) hydrogen atom of C₁-C₆ alkyl is substituted by hydroxy.

In some embodiments of formula I or Ia, at least one of R³ and R⁴ comprises at least one (e.g., 1, 2, or 3) hydroxy group. In some embodiments, R³ and R⁴ each comprise a hydroxy group. In some embodiments, at least one of R³ and R⁴ comprises two hydroxy groups (e.g., a diol).

In some embodiments of formula I or Ia, at least one of R³ and R⁴ is not H. In some embodiments, both of R³ and R⁴ are not H.

In some embodiments of formula I or Ia, R³ is H, alkyl (e.g., C₁-C₆ alkyl), or aryl (e.g., C₆-C₁₀ aryl). In some embodiments, R³ is alkyl (e.g., C₁-C₆ alkyl) or aryl (e.g., C₆-C₁₀ aryl). In some embodiments, R³ is H, C₁-C₆ alkyl, or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl. In some embodiments, R³ is C₁-C₆ alkyl or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl. In some embodiments, R³ comprises a hydroxy group.

In some embodiments of formula I or Ia, R⁴ is alkyl (e.g., C₁-C₆ alkyl) or aryl (e.g., C₆-C₁₀ aryl). In some embodiments, R⁴ is C₁-C₆ alkyl or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl. In some embodiments, R⁴ comprises a hydroxy group.

In some embodiments of formula I or Ia, R³ and R⁴ come together on the nitrogen atom to which they are attached to form a 3- to 12-membered heterocycle, wherein each hydrogen atom of 3- to 12-membered heterocycle is independently optionally substituted by halogen, hydroxy, amino, C₁-C₆ alkoxy, or C₁-C₆ alkyl, or C₆-C₁₀ aryl. In some embodiments, R³ and R⁴ come together on the nitrogen atom to which they are attached to form a 3- to 12-membered heterocycle, wherein each hydrogen atom of 4- to 8-membered heterocycle is independently optionally substituted by halogen, hydroxy, amino, C₁-C₆ alkoxy, or C₁-C₆ alkyl, or C₆-C₁₀ aryl. In some embodiments, R³ and R⁴ come together on the nitrogen atom to which they are attached to form a 4- to 8-membered heterocycle, wherein at least one (e.g., 1, 2, or 3) hydrogen atom of 4- to 8-membered heterocycle is substituted by hydroxy.

In some embodiments, the eugenol derivative comprises:

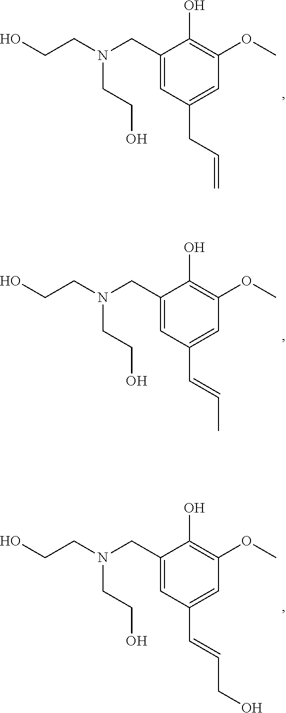 [SMILES: C=CCc1cc(CN(CCO)CCO)c(O)c(OC)c1 ; C/C=C/c1cc(CN(CCO)CCO)c(O)c(OC)c1 ; COc1cc(/C=C/CO)cc(CN(CCO)CCO)c1O]

any combination thereof.

In some embodiments, the eugenol derivative is provided by (i) reacting an aldehyde and an amine, thereby providing an intermediate, and (ii) reacting the intermediate with eugenol, isoeugenol, or coniferyl alcohol, thereby providing the eugenol derivative. In some embodiments, the eugenol derivative is provided by method comprising a Mannich-like condensation reaction.

In some embodiments, the method includes producing the eugenol derivative by (i) contacting (e.g., reacting) an aldehyde and an amine, thereby providing an intermediate, and (ii) contacting (e.g., reacting) the intermediate with eugenol, isoeugenol, or coniferyl alcohol, thereby providing the eugenol derivative. In some embodiments, the step or producing the eugenol derivative comprises a Mannich-like condensation reaction.

In some embodiments, the step of contacting an aldehyde and an amine may be carried out using a molar ratio of amine to aldehyde of about 5:1 to about 1:5, for example, about 4:1 to about 1:4, about 3:1 to about 1:3, about 2:1 to about 1:2, about 4:1 to about 1:1, about 3:1 to about 1:1, about 2:1 to about 1:1, about 1:1 to about 1:4, about 1:1 to about 1:3, about 1:1 to about 1:2, or about 1:1.

In some embodiments, the step of contacting an aldehyde and an amine may be carried out at a temperature of about 25 °C to about 150 °C, for example, about 25 °C to about 125 °C, about 25 °C to about 100 °C, about 25 °C to about 80 °C, about 40 °C to about 150 °C, about 40 °C to about 125 °C, about 40 °C to about 100 °C, or about 40 °C to about 80 °C.

In some embodiments, the step of contacting an aldehyde and an amine may be carried out for about 0.5 hours to about 24 hours, for example, about 0.5 hours to about 18 hours, about 0.5 hours to about 12 hours, about 0.5 hours to about 6 hours, about 0.5 hours to about 4 hours, about 1 hour to about 12 hours, about 1 hour to about 6 hours, or about 1 hour to about 4 hours.

In some embodiments, the aldehyde is formaldehyde, acetaldehyde, benzaldehyde, vanillin, salicylaldehyde, glyoxal, furfural, glyoxylic acid, and any combination thereof. The aldehyde is not particularly limited, and any suitable aldehyde source may be employed. Formaldehyde, for example, may be provided as formalin, paraformaldehyde, or combinations thereof.

In some embodiments, the amine is a primary or a secondary amine. In some embodiments, the amine is an amino alcohol or an amino diol. The amine is not particularly limited, and any suitable amine source may be employed. In some embodiments, the amine is ethanolamine or diethanolamine.

In some embodiments, the step of contacting the intermediate with eugenol, isoeugenol, or coniferyl alcohol may be carried out using a molar ratio of intermediate to eugenol, isoeugenol, or coniferyl alcohol of about 5:1 to about 1:5, for example, about 4:1 to about 1:4, about 3:1 to about 1:3, about 2:1 to about 1:2, about 4:1 to about 1:1, about 3:1 to about 1:1, about 2:1 to about 1:1, about 1:1 to about 1:4, about 1:1 to about 1:3, about 1:1 to about 1:2, or about 1:1.

In some embodiments, the step of contacting a the intermediate with eugenol, isoeugenol, or coniferyl alcohol may be carried out at a temperature of about 50 °C to about 150 °C, for example, about 50 °C to about 125 °C, about 50 °C to about 100 °C, about 75 °C to about 150 °C, about 75 °C to about 125 °C, or about 75 °C to about 100 °C.

In some embodiments, the step of contacting the intermediate with eugenol, isoeugenol, or coniferyl alcohol may be carried out for about 2 hours to about 48 hours, for example, about 6 hours to about 24 hours, about 6 hours to about 18 hours, about 12 hours to about 24 hours, or about 12 hours to about 18 hours.

In some embodiments, the method includes heating the oxidizable fluid to a temperature of about 20 °C to about 250 °C. For example, the heating may be carried out at temperatures less than about 250 °C, less than about 200 °C, about 20 °C to about 200 °C, about 20 °C to about 175 °C, about 20 °C to about 150 °C, about 20 °C to about 125 °C, about 20 °C to about 100 °C, about 50 °C to about 250 °C, about 50 °C to about 200 °C, about 50 °C to about 175 °C, about 50 °C to about 150 °C, about 50 °C to about 125 °C, about 50 °C to about 100 °C, about 100 °C to about 250 °C, about 100 °C to about 200 °C, about 100 °C to about 175 °C, about 100 °C to about 150 °C, or about 100 °C to about 125 °C.

In some embodiments, the composition comprises an additional component selected from the group consisting of a solvent, an additional antioxidant, and combinations thereof.

If a composition of the present disclosure comprises an additional component, the amount of additional component in the composition is not particularly limited. For example, a composition of the present disclosure may comprise from about 0.1 wt. % to about 99 wt. % of an additional component, such as about 1 wt. % to about 99 wt. %, about 1 wt. % to about 75 wt. %, about 1 wt. % to about 50 wt. %, about 1 wt. % to about 25 wt. %, about 10 wt. % to about 99 wt. %, about 25 wt. % to about 99 wt. %, about 50 wt. % to about 99 wt. %, about 75 wt. % to about 99 wt. %, about 60 wt. % to about 95 wt. %, or about 75 wt. % to about 95 wt. %.

In some embodiments, the composition comprises a solvent. A concentrate including the eugenol derivative can be present in a composition with a solvent, or a combination of solvents. A solvent or solvent combination can be chosen so that the eugenol derivative is soluble in the solvent or solvent combination. Useful solvents include any solvent in which the eugenol derivative is soluble or can be stably suspended. In some embodiments, a solvent or solvent combination can be selected from an alcohol, a hydrocarbon, a ketone, an ether, an alkylene glycol, a glycol ether, an amide, a nitrile, a sulfoxide, an ester, and any combination thereof.

In some embodiments, a solvent or solvent combination can be selected from methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, kerosene, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

In some embodiments, a solvent or solvent combination can be selected from water soluble or water miscible solvents such glycol-based solvents and hydrophobic or hydrocarbon solvents such as aromatic solvents, paraffinic solvents, or combinations thereof.

Examples of glycol solvents include, but are not limited to, C₁-C₈ glycols such as ethylene glycol, propylene glycol, diethylene glycol, and triethylene glycol, ethers of such glycols such as diethylene glycol monobutyl ether, diethylene glycol monomethyl ether, diethylene glycol monoethyl ether, diethylene glycol monobutyl ether, triethylene glycol, triethylene glycol monomethyl ether, liquid polyethylene glycol, dipropylene glycol, dipropylene glycol monomethyl ether, dipropylene glycol monoethyl ether, and a low molecular weight polypropylene glycol and the like and combinations thereof. Commercial solvents, such as Butyl Carbitol™ and Butyl CELLOSOLVE™, which include ethylene glycol monobutyl ether, may also be used.

Examples of hydrophobic or hydrocarbon solvents include, but are not limited to, heavy aromatic naphtha, toluene, ethylbenzene, isomeric hexanes, benzene, xylene, such as ortho-xylene, para-xylene, or meta-xylene, and mixtures of two or more thereof.

If a composition of the present disclosure comprises a solvent, the amount of solvent in the composition is not particularly limited. For example, a composition of the present disclosure may comprise from about 0.1 wt. % to about 99 wt. % of a solvent, such as about 1 wt. % to about 99 wt. %, about 1 wt. % to about 75 wt. %, about 1 wt. % to about 50 wt. %, about 1 wt. % to about 25 wt. %, about 10 wt. % to about 99 wt. %, about 25 wt. % to about 99 wt. %, about 50 wt. % to about 99 wt. %, about 75 wt. % to about 99 wt. %, about 60 wt. % to about 95 wt. %, or about 75 wt. % to about 95 wt. %.

In some embodiments, the composition comprises an additional antioxidant. These optional additional antioxidants can include, for example, a sterically hindered phenol (e.g., 2,6-di-tert-butylphenol), and/or an alkylated diphenylamine. In a concentrated composition (e.g., a concentrate), the one or more optional additional antioxidants can also be at a high concentration along with the eugenol derivative antioxidant, so that when the concentrate is diluted these components are provided at working concentrations (e.g., ppm).

The compositions disclosed herein may include or exclude an additional antioxidant. For example, the compositions may include or exclude eugenol, isoeugenol, coniferyl alcohol, a sterically hindered phenol (e.g., 2,6-di-tert-butylphenol), and/or an alkylated diphenylamine. In some embodiments, the composition excludes eugenol, isoeugenol, or coniferyl alcohol.

If a composition of the present disclosure comprises an additional antioxidant, the amount of additional antioxidant in the composition is not particularly limited. For example, a composition of the present disclosure may comprise from about 0.1 wt. % to about 99 wt. % of an additional antioxidant, such as about 1 wt. % to about 99 wt. %, about 1 wt. % to about 75 wt. %, about 1 wt. % to about 50 wt. %, about 1 wt. % to about 25 wt. %, about 10 wt. % to about 99 wt. %, about 25 wt. % to about 99 wt. %, about 50 wt. % to about 99 wt. %, about 75 wt. % to about 99 wt. %, about 60 wt. % to about 95 wt. %, or about 75 wt. % to about 95 wt. %.

A composition of the present disclosure can optionally include one or more additional components, such as additives, that could be beneficial for use in the oxidizable fluids as described herein at a working concentration. These optional additives can include, for example, a chelating agent, a dispersant or detergents, a de-emulsifier, a defoamer, or combinations thereof. In a concentrated composition (e.g., a concentrate), the one or more optional additives can also be at a high concentration along with the eugenol derivative antioxidant, so that when the concentrate is diluted these components are provided at working concentrations (e.g., ppm).

If a composition of the present disclosure comprises an additive, the amount of additive in the composition is not particularly limited. For example, a composition of the present disclosure may comprise from about 0.1 wt. % to about 50 wt. % of an additive, such as about 1 wt. % to about 50 wt. %, about 10 wt. % to about 50 wt. %, about 20 wt. % to about 50 wt. %, about 30 wt. % to about 50 wt. %, about 40 wt. % to about 50 wt. %, about 0.1 wt. % to about 40 wt. %, about 0.1 wt. % to about 30 wt. %, about 0.1 wt. % to about 20 wt. %, or about 0.1 wt. % to about 10 wt. %.

In some embodiments, the composition comprises from about 0.001 wt. % to about 100 wt. % of the eugenol derivative, such as from about 0.001 wt. % to about 75 wt. %, about 0.001 wt. % to about 50 wt. %, about 0.001 wt. % to about 25 wt. %, about 0.001 wt. % to about 10 wt. %, about 0.001 wt. % to about 5 wt. %, about 1 wt. % to about 100 wt. %, about 5 wt. % to about 100 wt. %, about 10 wt. % to about 100 wt. %, about 25 wt. % to about 100 wt. %, about 50 wt. % to about 100 wt. %, or about 75 wt. % to about 100 wt. % of the eugenol derivative.

In some embodiments, the effective amount of the composition is added to the oxidizable fluid to provide a concentration of about 0.0001 wt. % to about 50 wt. % of the eugenol derivative in the oxidizable fluid. For example, the effective amount of the composition is added to the oxidizable fluid to provide a concentration of about 0.0001 wt. % to about 25 wt. %, about 0.0001 wt. % to about 10 wt. %, about 0.0001 wt. % to about 5 wt. %, about 0.0001 wt. % to about 2.5 wt. %, about 0.0001 wt. % to about 1 wt. %, about 0.0001 wt. % to about 0.1 wt. %, about 0.001 wt. % to about 25 wt. %, about 0.001 wt. % to about 10 wt. %, about 0.001 wt. % to about 5 wt. %, about 0.001 wt. % to about 2.5 wt. %, about 0.001 wt. % to about 1 wt. %, about 0.001 wt. % to about 0.1 wt. %, about 0.01 wt. % to about 25 wt. %, about 0.01 wt. % to about 10 wt. %, about 0.01 wt. % to about 5 wt. %, about 0.01 wt. % to about 2.5 wt. %, about 0.01 wt. % to about 1 wt. %, or about 0.01 wt. % to about 0.1 wt. % of the eugenol derivative in the oxidizable fluid.

In some embodiments, the effective amount of the composition is added to the oxidizable fluid to provide a concentration of about 1 ppm to about 10,000 ppm of the eugenol derivative in the oxidizable fluid. For example, the effective amount of the composition is added to the oxidizable fluid to provide a concentration of about 1 ppm to about 5,000 ppm, about 1 ppm to about 3,000 ppm, about 1 ppm to about 2,000 ppm, about 1 ppm to about 1,500 ppm, about 1 ppm to about 1,000 ppm, about 1 ppm to about 750 ppm, about 1 ppm to about 500 ppm, about 1 ppm to about 250 ppm, about 10 ppm to about 10,000 ppm, about 10 ppm to about 5,000 ppm, about 10 ppm to about 3,000 ppm, about 10 ppm to about 2,000 ppm, about 1 ppm to about 1,500 ppm, about 10 ppm to about 1,000 ppm, about 10 ppm to about 750 ppm, about 10 ppm to about 500 ppm, about 10 ppm to about 250 ppm, about 100 ppm to about 10,000 ppm, about 100 ppm to about 5,000 ppm, about 100 ppm to about 3,000 ppm, about 100 ppm to about 2,000 ppm, about 100 ppm to about 1,500 ppm, about 100 ppm to about 1,000 ppm, about 100 ppm to about 750 ppm, about 100 ppm to about 500 ppm, about 250 ppm to about 10,000 ppm, about 250 ppm to about 5,000 ppm, about 250 ppm to about 3,000 ppm, about 250 ppm to about 2,000 ppm, about 250 ppm to about 1,500 ppm, about 250 ppm to about 1,000 ppm, or about 250 ppm to about 750 ppm of the eugenol derivative in the oxidizable fluid.

While carrying out the methods of the present disclosure, the compositions and/or additives disclosed herein may be applied to an oxidizable fluid batch-wise, continuously, or semi-continuously.

The compositions and/or additives disclosed herein may be added to a fluid using a variety of different application methods known in the art. In some embodiments, the compositions and/or additives may be added continuously or intermittently to the oxidizable fluid, either automatically or manually, by using, for example, chemical injection pumps. The addition may involve dripping, pouring, spraying, pumping, injecting, or otherwise adding the composition and/or additive to the oxidizable fluid.

In some embodiments, the oxidizable fluid is an industrial fluid. In some embodiments, the oxidizable fluid comprises an oil. In some embodiments, the oxidizable fluid is selected from the group consisting of a vegetable oil, a seed oil, a pyrolysis oil, a biodiesel, a hydrocarbon, crude oil, a metal-working fluid, a lubricant, and any combination thereof. In some embodiments, the oxidizable fluid is selected from the group consisting of a vegetable oil, a seed oil, an animal oil, a pyrolysis oil, a biodiesel, a hydraulic fluid, a hydrocarbon, crude oil, a metal-working fluid, a lubricant, and any combination thereof.

The eugenol derivative antioxidant can be directly added to any type of fluid, either refined or unrefined, to provide antioxidant activity and hinder oxidation of fluid components therein.

In some embodiments, the oxidizable fluid is a pyrolysis oil (i.e., derived from plastic), a crude oil (i.e., derived from petroleum), a hydrocarbon, or combinations thereof. In some embodiments, the oxidizable fluid comprises paraffin compounds, isoparaffins, olefins, diolefins, naphthenes, aromatics, and combinations thereof. In some embodiments, the oxidizable fluid comprises varying amounts of olefins and diolefins.

In some embodiments, the oxidizable fluid is a bio-based fuel or biolubricant. In some embodiments, the oxidizable fluid is a biodiesel, which can be a refined or distilled biodiesel, a crude biodiesel, or a biodiesel that has both crude and refined components. A biodiesel is typically prepared by the esterification of animal and/or vegetable oils. For example, some vegetable oils that are used for preparation of biodiesel include palm oil, soybean oil, rapeseed oil, sesame oil, sunflower oil, grape seed oil, olive oil, and cottonseed oil. Some animal oils that are used for preparation of biodiesel include selected from fish oil, and fat from animals, such as pigs and chickens.

In some embodiments, the oxidizable fluid is a vegetable oil, a seed oil, an animal oil, or combinations thereof. Vegetable oils and seed oils are commonly extracted from seeds or other parts of vegetables and fruits. For example, common vegetable and seed oils include palm oil, soybean oil, rapeseed oil, sesame oil, sunflower oil, grape seed oil, olive oil, and cottonseed oil. Common animal oils include fish oil, and fat from animals, such as pigs and chickens.

A fluid treated with a composition of the present disclosure can be at any selected temperature, such as ambient temperature or an elevated temperature. For example, the medium may be at a temperature of from about 40 °C to about 250 °C. In some embodiments, the medium may be at a temperature of from about −50 °C to about 300 °C, about 0 °C to about 200 °C, about 10 °C to about 100 °C, or about 20 °C to about 90 °C.

A fluid treated with a composition of the present disclosure has a significantly improved oxidative stability as compared to a fluid that does not comprise a composition of the present disclosure. In some embodiments, the treated fluid undergoes an improvement in oxidative stability of about 10% to about 1000% compared to the untreated fluid, or about 10% to about 100%, about 50% to about 100%, about 50% to about 200%, about 100% to about 200%, about 100% to about 1000%, about 100% to about 800%, about 200% to about 1000%, about 200% to about 800%, about 500% to about 1000%, or about 500% to about 800% compared to the corresponding untreated fluid.

The percent improvement in oxidative stability may be measured as a relative improvement in oxidation stability index (OSI), oxidation induction time (OIT), or oxidation temperature (OT) within the treated fluid compared to the untreated fluid. OSI may be measured by the Rancimat (i.e., a modified EN 14112) test method described herein. OIT may be measured by a PDSC OIT test method described herein. OT may be measured by a PDSC OT test method described herein. A higher OSI, OIT, and/or OT may indicate a higher oxidative stability.

In some embodiments, the composition provides an oxidation stability index (OSI) (at a temperature between 100 °C and 200 °C) of greater than about 50 min, greater than about 75 min, greater than about 100 min, or greater than about 150 min. For example, the composition may provide an OSI of about 50 min to about 500 min, about 50 min to about 250 min, about 75 min to about 500 min, about 75 min to about 250 min, about 100 min to about 500 min, or about 100 min to about 250 min.

In some embodiments, the composition provides an oxidation induction time (OIT) (at a temperature between 100 °C and 200 °C) of greater than about 5 min, greater than about 6 min, greater than about 8 min, greater than about 10 min, greater than about 12 min, greater than about 15 min, greater than about 20 min, or greater than about 25 min. For example, the composition may provide an OIT of about 5 min to about 100 min, about 5 min to about 50 min, about 5 min to about 25 min, about 10 min to about 100 min, about 10 min to about 50 min, or about 10 min to about 25 min.

In some embodiments, the composition provides an oxidation temperature (OT) (at a ramp rate of 10 °C/min) of greater than about 100 °C, greater than about 120 °C, greater than about 140 °C, greater than about 150 °C, greater than about 160 °C, greater than about 180 °C, or greater than about 200 °C. For example, the composition may provide an OT of about 100 °C to about 250 °C, about 100 °C to about 225 °C, about 100 °C to about 200 °C, about 150 °C to about 250 °C, about 150 °C to about 225 °C, or about 150 °C to about 200 °C.

The foregoing may be better understood by reference to the following examples, which are intended for illustrative purposes and are not intended to limit the scope of the disclosure or its application in any way.

### Examples

### Materials and Methods

Synthesis Method: The following is a representative synthetic scheme that was carried out to produce an embodiment of a eugenol derivative:

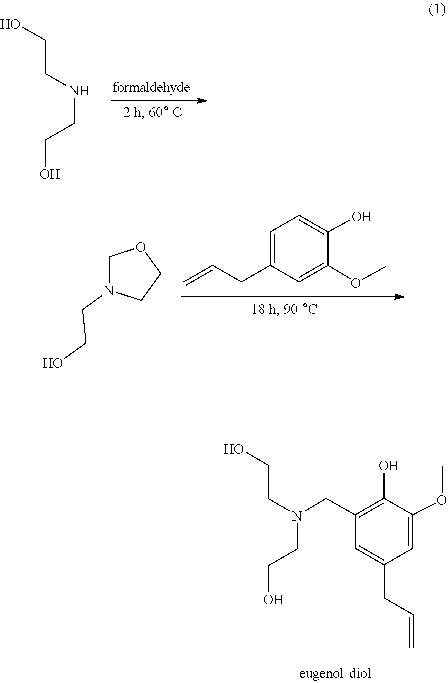

A representative eugenol derivative was synthesized following a method reported in Progress in Organic Coatings, 148, 2020, 105826. First, an oxazolidine intermediate is formed by reaction of formalin (formaldehyde) and diethanolamine. Then, eugenol is then reacted with the oxazolidine intermediate to obtain eugenol derivative (i.e., eugenol diol) used in the following examples. Scheme 1 above depicts synthesis of antioxidant chemistry disclosed herein.

Rancimat Method: OSI was measured by Rancimat test using modified Standard Test Method EN 14112, using an air stream that was passed through 7.5 g of a sample of the composition, at a temperature of 100 °C, and at an airflow of 10 L/h, and an antioxidant concentration of 400 ppm.

PDSC OIT method: In PDSC oxidation induction time method, a sample of pyrolysis oil is heated to a temperature (e.g., about 130 °C, 160 °C, or 170 °C) under increased oxygen pressure (e.g., about 500 psi). Once the target temperature is achieved, the sample remains subjected to the thermo-oxidative conditions in isothermal mode until the oxidation begins. The onset of exothermic oxidation is called the oxidation induction time (OIT). A higher OIT indicates a higher oxidative stability.

The test parameters were as follows: Instrument: DSC25P; Isothermal Temp: about 130 °C, 160 °C, or 170 °C; Purge gas: Oxygen (about 500 PSI); Pan type: Aluminum pan; Sample Mass: about 5 mg; and Ramp about 10 °C/min to 130 °C, 160 °C, or 170 °C.

### Example 1: Performance of Eugenol Diol Vs Eugenol and 2,6-DTBP in Stabilization of Biodiesel Under Thermo-Oxidative Conditions of PDSC

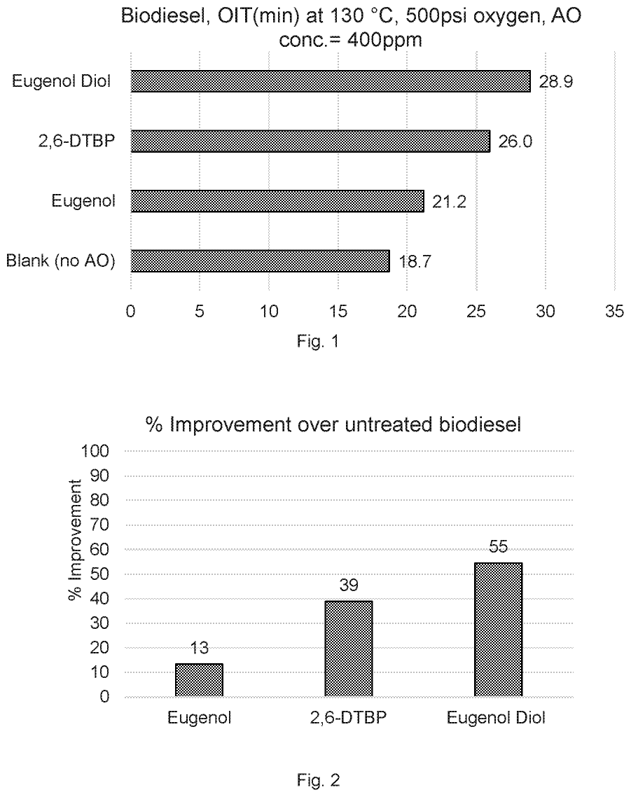

Results are presented in FIGS. 1-2. Blank biodiesel had oxidative stability (PDSC, OIT measured at 130 °C) of 18.7 min. While eugenol and 2,6-di-tert butylphenol used at 400 ppm, increased the induction time to 21.2 and 26.0 min, respectively, a greater increase in induction time of 28.9 min was observed when eugenol diol was used at 400 ppm. Eugenol diol prolonged the induction time by 55% relative to the induction time without an antioxidant. These results also show eugenol diol provided superior antioxidant activity over the tested antioxidants.

### Example 2: Performance of Eugenol Diol Vs Eugenol and 2,6-DTBP in Stabilization of Biodiesel Under Thermo-Oxidative Conditions of Rancimat

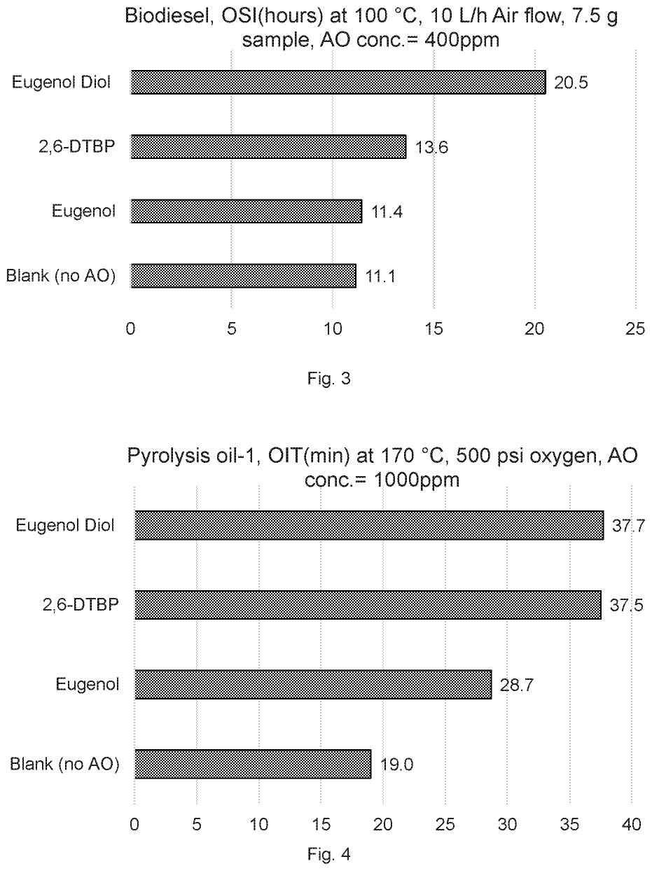

Results are presented in FIG. 3. Blank biodiesel had oxidative stability (Rancimat, OSI measured at 100 °C) of 11.1 hours. While eugenol and 2,6-di-tert butylphenol used at 400 ppm, increased the OSI to 11.4 hours and 13.6 hours, respectively, a greater increase in induction time of 20.5 hours was observed when eugenol diol was used at 400 ppm. Eugenol diol prolonged the induction time by 84% relative to the induction time without an antioxidant. These results also show eugenol diol provided superior antioxidant activity over the tested antioxidants.

### Example 3: Performance of Eugenol Diol Vs Eugenol and 2,6-DTBP for Stabilization of Pyrolysis Oil-1 Under Thermo-Oxidative Conditions of PDSC

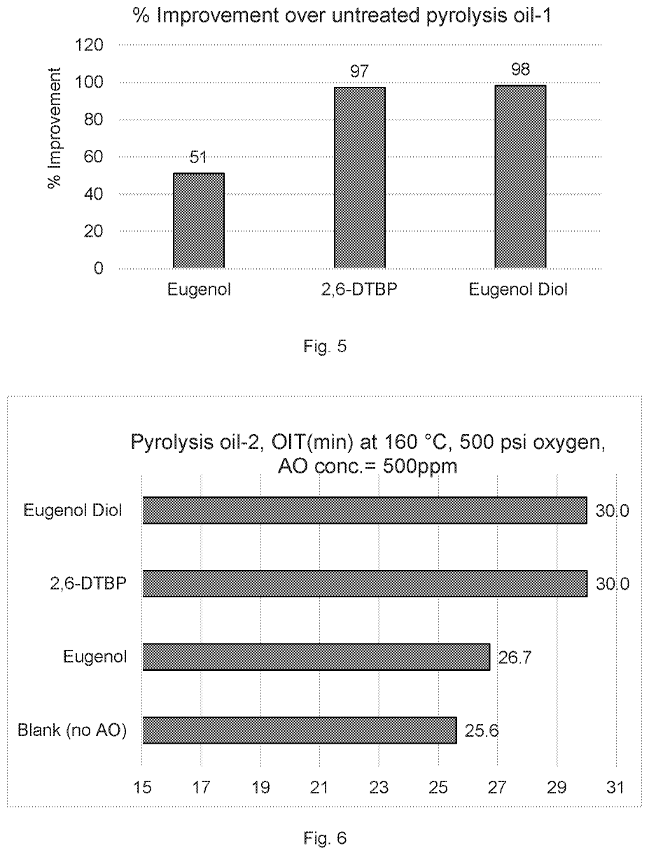

Results are presented in FIGS. 4-5. Blank pyrolysis oil-1 had oxidative stability (PDSC, OIT measured at 170 °C) of 19.0 min. While eugenol and 2,6-di-tert butylphenol used at 1000 ppm, increased the induction time to 28.7 and 37.5 min, respectively, a greater increase in induction time of 37.7 min was observed when eugenol diol was used at 1000 ppm. Eugenol diol prolonged the induction time by 98% relative to the induction time without an antioxidant. These results also show eugenol diol provided superior antioxidant activity over the tested antioxidants.

### Example 4: Performance of Eugenol Diol Vs Eugenol and 2,6-DTBP for Stabilization of Pyrolysis Oil-2 Under Thermo-Oxidative Conditions of PDSC

Results are presented in FIG. 6. Blank pyrolysis oil-2 had oxidative stability (PDSC, OIT measured at 160 °C) of 25.6 min. While eugenol used at 1000 ppm increased the induction time to 26.7 min, a greater increase in induction time of 30.0 min was observed when eugenol diol was used at 1000 ppm. These results also show eugenol diol provided superior antioxidant activity over eugenol.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a eugenol derivative” is intended to include “at least one eugenol derivative” or “one or more eugenol derivatives.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, reaction product, component, compound and/or additive disclosed herein or any combination of two or more of the elements, reaction products, components, compounds or additives disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25 °C with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method for stabilizing a fluid, comprising:
adding a composition comprising a eugenol derivative to the oxidizable fluid.

2. The method of claim 1, wherein the eugenol derivative is of formula I: 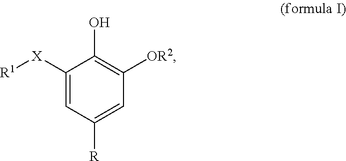
or a salt thereof, wherein:
X is C₁-C₆ alkylene;
R is C₂-C₆ alkenyl;
R¹ is —NR³R⁴;
R² is C₁-C₆ alkyl; and
R³ and R⁴ are each independently H, C₁-C₆ alkyl, or C₆-C₁₀ aryl;
provided that at least one of R³ and R⁴ is not H.

3. The method of claim 1, wherein the eugenol derivative is of formula Ia: 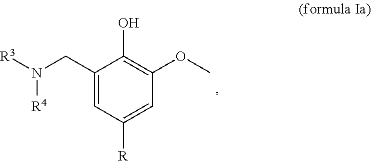
or a salt thereof, wherein:
R is C₂-C₆ alkenyl, wherein each hydrogen atom of C₂-C₆ alkenyl is independently optionally substituted by halogen, hydroxy, amino, C₁-C₆ alkoxy, C₁-C₆ alkyl, or C₆-C₁₀ aryl; and
R³ and R⁴ are each independently H, C₁-C₆ alkyl, or C₆-C₁₀ aryl, wherein each hydrogen atom of C₁-C₆ alkyl or C₆-C₁₀ aryl is independently optionally substituted by halogen, hydroxy, amino, C₁-C₆ alkoxy, C₁-C₆ alkyl, or C₆-C₁₀ aryl; or R³ and R⁴ come together on the nitrogen atom to which they are attached to form a 3- to 12-membered heterocycle, wherein each hydrogen atom of 3- to 12-membered heterocycle is independently optionally substituted by halogen, hydroxy, amino, C₁-C₆ alkoxy, or C₁-C₆ alkyl, or C₆-C₁₀ aryl; provided that at least one of R³ and R⁴ is not H.

4. The method of claim 3, wherein R³ and R⁴ are each independently C₁-C₆ alkyl, wherein each hydrogen atom of C₁-C₆ alkyl is independently optionally substituted by halogen, hydroxy, amino, or C₁-C₆ alkoxy.

5. The method of claim 3, wherein at least one of R³ and R⁴ is C₁-C₆ alkyl, wherein at least one hydrogen atom of C₁-C₆ alkyl is substituted by hydroxy.

6. The method of claim 2, wherein R¹ comprises a diol.

7. The method of claim 2, wherein R¹ is:

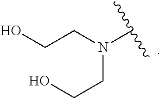 [SMILES: *N(CCO)CCO]

8. The method of claim 1, wherein the eugenol derivative comprises: 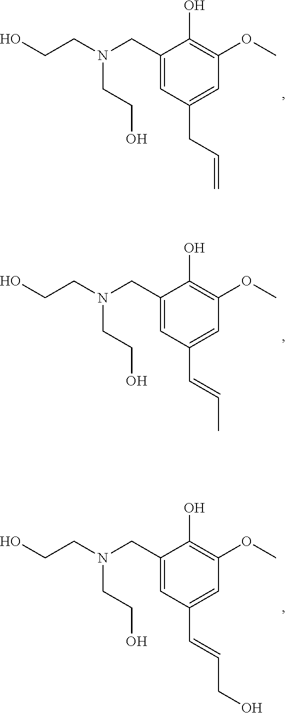 [SMILES: C=CCc1cc(CN(CCO)CCO)c(O)c(OC)c1 ; C/C=C/c1cc(CN(CCO)CCO)c(O)c(OC)c1 ; COc1cc(/C=C/CO)cc(CN(CCO)CCO)c1O]
any combination thereof.

9. The method of claim 1, further comprising producing the eugenol derivative by (i) reacting an aldehyde and an amine, thereby providing an intermediate, and (ii) reacting the intermediate with eugenol, isoeugenol, or coniferyl alcohol, thereby providing the eugenol derivative.

10. The method of claim 9, wherein the aldehyde comprises formaldehyde, acetaldehyde, benzaldehyde, vanillin, furfural, salicylaldehyde, glyoxal, glyoxylic acid, or any combination thereof and wherein the amine is a primary or a secondary amine optionally comprising a diol.

11. The method of claim 1, wherein the composition further comprises an additional component selected from the group consisting of a solvent, an additional antioxidant, and any combination thereof.

12. The method of claim 11, wherein the solvent is selected from the group consisting of an alcohol, a hydrocarbon, a ketone, an ether, an alkylene glycol, a glycol ether, an amide, a nitrile, a sulfoxide, an ester, and any combination thereof.

13. The method of claim 1, wherein the composition excludes eugenol, isoeugenol, coniferyl alcohol, or any combination thereof.

14. The method of claim 1, wherein the fluid comprises a vegetable oil, a seed oil, a pyrolysis oil, a biodiesel, a hydrocarbon, crude oil, a metal-working fluid, a lubricant, or any combination thereof.

15. The method of claim 1, further comprising preventing or inhibiting oxidation of the oxidizable fluid.

16. The method of claim 1, further comprising heating the oxidizable fluid to a temperature of about 20 °C to about 250 °C.

17. A composition, comprising:
an oxidizable substrate and a eugenol derivative,
wherein the oxidizable substrate is an oxidizable fluid selected from the group consisting of a vegetable oil, a seed oil, a pyrolysis oil, a biodiesel, a hydrocarbon, crude oil, a metal-working fluid, a lubricant, or any combination thereof.

18. The composition of claim 17, wherein the eugenol derivative is of formula I: 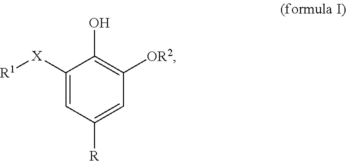
or a salt thereof, wherein:
X is C₁-C₆ alkylene;
R is C₂-C₆ alkenyl;
R¹ is —NR³R⁴;
R² is C₁-C₆ alkyl; and
R³ and R⁴ are each independently H, C₁-C₆ alkyl, or C₆-C₁₀ aryl;
provided that at least one of R³ and R⁴ is not H.

19. The composition of claim 17, wherein the eugenol derivative comprises: 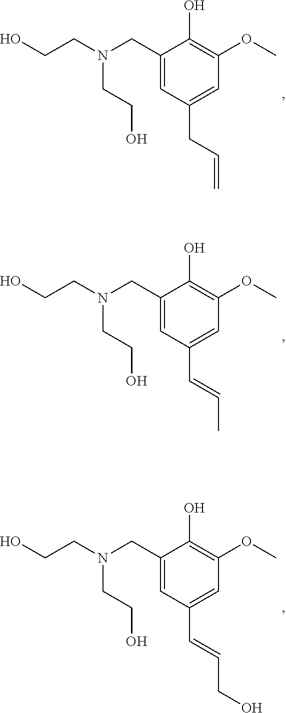 [SMILES: C=CCc1cc(CN(CCO)CCO)c(O)c(OC)c1 ; C/C=C/c1cc(CN(CCO)CCO)c(O)c(OC)c1 ; COc1cc(/C=C/CO)cc(CN(CCO)CCO)c1O]
any combination thereof.

20. The composition of claim 17, wherein the composition excludes eugenol, isoeugenol, coniferyl alcohol, and combinations thereof.
